(19) United States
(12) Patent Application Publication
(10) Pub. No.: US 2020/0270512 A1
(43) Pub. Date: Aug. 27, 2020

(54) Breaking Gel Compositions Containing Nanoparticles

(71) Applicant: Halliburton Energy Services, Inc., Houston, TX (US)

(72) Inventors: Dipti Singh, Kingwood, TX (US); Ruslan Gashimov, Humble, TX (US); Dustin James Durbin, Angleton, TX (US)

(73) Assignee: Halliburton Energy Services, Inc., Houston, TX (US)

(21) Appl. No.: 16/325,519

(22) PCT Filed: Sep. 22, 2016
(86) PCT No.: PCT/US2016/053108

§ 371 Date: Feb. 14, 2019

(51) Int. Cl. C09K 8/68; C09K 8/14

(52) U.S. Cl. CPC C09K 8/685; C09K 2208/26; C09K 2208/10; C09K 8/14

(57) ABSTRACT

A composition and method for treating a subterranean formation that includes preparing a treatment gel of aqueous fluid, a thickening agent and nanoparticles. Placing the treatment gel in at least a portion of the subterranean formation and placing a gel breaker in at least a portion of the subterranean formation to break the treatment gel to a residual treatment fluid having decreased viscosity.

### CROSS-REFERENCE TO RELATED APPLICATIONS

None.

### FIELD

The present disclosure relates to gel compositions containing nanoparticles and the use of the gel composition in oil and gas related applications. More particularly, the present disclosure relates to methods of fracturing subterranean formations to stimulate or increase hydrocarbon production utilizing gel compositions and methods of breaking the gel compositions after treatment.

### BACKGROUND

Generally, well treatments of an oil or gas well involve the injection of a fluid into the formation to stimulate production from the well by increasing the permeability of the oil or gas through the formation.

A widely used stimulation technique is hydraulic fracturing, in which a fracturing fluid is injected through a well into the surrounding formation at a sufficient pressure to fracture the formation adjacent to the well. These induced fractures create channels for fluid flow through the formation back to the well. Usually a particulate material, referred to as a “proppant,” is deposited into the fracture to help prop the fracture open for fluid flow back after the hydraulic pressure is released.

Often a high-viscosity fracturing fluid containing proppant is used for the fracturing operation. The fracture is initiated and continues to grow as more fluid and proppant are introduced into the formation. A reduction in fluid viscosity along with fluid leak-off from the created fracture into permeable areas of the formation allows the fracture to close on the proppant. A reduction in fluid viscosity can be induced by hydrolysis of the polymers at the higher temperature from the formation. The proppant holds the fracture open and provides a highly conductive pathway for flow of hydrocarbons and/or other formation fluids, thus increasing the rate at which fluids can be produced by the formation.

Guar gum is commonly used to increase the viscosity of fracturing fluids. The seeds of the guar bean contain a large endosperm that consists of a very large polysaccharide of galactose and mannose. This polymer is water-soluble and exhibits a viscosifying effect in water. Guar gum is used in many different applications to modify viscosity in food products and in industrial uses. Fracturing fluids having very high viscosity are needed for proppant suspension and transport and to create the desired fracture geometry. It may not be possible to obtain the desired high viscosity by simply increasing the concentration of the guar or other biopolymers which can be used as gelling agents in fracturing operations. Biopolymer-based fracturing fluids can be limited by other disadvantages such as hydration limitations of the polymer, potential formation damage from undesirable coating of formation surfaces with the polymer or residue, and instability of the polymer at elevated temperatures in certain types of fracturing applications. Biopolymer-based fracturing fluids such as guar-based fracturing fluids can be particularly limited by the instability of the polymer at elevated temperatures from unconventional reservoirs, where the polymer can break down prematurely and undermine a fracturing operation.

Certain unconventional reservoirs such as hydrocarbon containing shale deposits, high temperature-high pressure formations, geothermal formations and other reservoirs that have properties other than the typical conventional reservoir may be particularly suited to the compositions and methods of the present disclosure. Horizontal wells can be difficult to fracture due to the length of horizontal section that the fracture fluid has to travel. The effect of gravity on the fracture fluid while it is traveling through a non-vertical section of wellbore encourages proppant settling. Wells having extended horizontal sections can be subject to proppant settling within the wellbore prior to reaching the formation to be fractured which can lead to ineffective completions and increased costs. A fracture fluid having increased viscosity and stability can be needed on such unconventional wells.

For higher viscosity fracturing fluids, gel compositions that include nanoparticles with a cross-linkable polymer soluble in an aqueous fluid can be used. These gel compositions can include a cross-linking agent. These gel compositions can be thermally resistant; they do not break down upon exposure of elevated temperature from the formation, which can be beneficial when treating certain high temperature formations such as deep hydrocarbon formations, unconventional reservoirs or geothermal wells. These thermally resistant gel compositions can remain stable upon high temperatures and can therefore transport the proppant into the formation to create fluid pathways that would not be formed using normal fracturing fluids.

Once these thermally resistant gel compositions have performed the fracturing operation there is a need to have the gel break, so that the flow of fluids through the new fracture can be achieved. Gel compositions containing clay nanoparticles can be particularly hard to break. It has been observed that conventional breakers, such as oxidizer breakers have not been successful in breaking these thermally resistant gel compositions, such as thermally resistant clay nanoparticle gel compositions.

Thus, there is a need for improved methods of treating subterranean formations to perform a fracturing treatment with thermally resistant gel compositions and then to break the gel so the flow of fluids through the new fracture can be achieved for optimal results.

### BRIEF DESCRIPTION OF DRAWINGS

The accompanying views of the drawing are incorporated into and form a part of the specification to illustrate aspects and examples of the present disclosure. The figures are only for the purpose of illustrating examples of how the various aspects of the disclosure can be made and used and are not to be construed as limiting the disclosure to only the illustrated and described examples.

FIG. 1 is a diagram illustrating an example of a fracturing system that may be used in accordance with certain embodiments of the present disclosure.

FIG. 2 is a diagram illustrating an example of a subterranean formation in which a fracturing operation may be performed in accordance with certain embodiments of the present disclosure.

FIG. 3 is a graph of viscosity and temperature vs time.

FIG. 4 is a photograph of a treatment gel being tested.

FIG. 5 is a graph of viscosity and temperature vs time.

FIG. 6 is a graph of viscosity and temperature vs time.

### DETAILED DESCRIPTION

The present disclosure provides a composition useful for fracturing a subterranean formation penetrated by a wellbore. The composition includes a thermally resistant gel containing nanoparticles along with a breaker package for breaking the gel. The present disclosure further provides a method of fracturing a subterranean formation penetrated by a wellbore. The method includes introducing into the subterranean formation a thermally resistant gel that contains proppant and then breaking the gel. The method can be particularly effective in utilizing cross-linkable polymer and gel compositions containing nanoparticles, such as clay nanoparticles.

Certain unconventional reservoirs such as extended reach non-vertical wells, high temperature formations, and geothermal formations may be particularly suited to the compositions and methods of the present disclosure. Wells needing extended proppant transport, such as wells having long horizontal sections that require increased viscosity and stability to reduce proppant settling may be particularly suited to the compositions and methods of the present disclosure.

Disclosed herein is a method for use in treating subterranean formations. In certain illustrative embodiments, a gel composition is used comprising an aqueous fluid, nanoparticles, a cross-linkable polymer that is soluble in the aqueous fluid, and a cross-linking agent. The gel composition is injected into the subterranean formation and allowed to penetrate the formation. The gel composition can be used in fracturing operations to create fractures and increase connectivity between existing pores and natural channels in the formation. The gel composition is then broken to remove substantially all of the gel components.

The exemplary methods and compositions disclosed herein may directly or indirectly affect one or more components or pieces of equipment associated with the preparation, delivery, recapture, recycling, reuse, and/or disposal of the disclosed compositions. For example, and with reference to FIG. 1, the disclosed methods and compositions may directly or indirectly affect one or more components or pieces of equipment associated with an exemplary fracturing system 10, according to one or more embodiments. In certain instances, the system 10 includes a fracturing fluid producing apparatus 20, a fluid source 30, a proppant source 40, and a pump and blender system 50 and resides at the surface at a well site where a well 60 is located. In certain instances, the fracturing fluid producing apparatus 20 combines a gel pre-cursor with fluid (e.g., liquid or substantially liquid) from fluid source 30, to produce a hydrated fracturing fluid that is used to fracture the formation. The hydrated fracturing fluid can be a fluid for ready use in a fracture stimulation treatment of the well 60 or a concentrate to which additional fluid is added prior to use in a fracture stimulation of the well 60. In other instances, the fracturing fluid producing apparatus 20 can be omitted and the fracturing fluid sourced directly from the fluid source 30. In certain instances, the fracturing fluid may comprise water, a hydrocarbon fluid, a polymer gel, foam, air, wet gases and/or other fluids.

The proppant source 40 can include a proppant for combination with the fracturing fluid. The system may also include additive source 70 that provides one or more additives (e.g., gelling agents, weighting agents, and/or other optional additives) to alter the properties of the fracturing fluid. For example, the other additives 70 can be included to reduce pumping friction, to reduce or eliminate the fluid's reaction to the geological formation in which the well is formed, to operate as surfactants, and/or to serve other functions.

The pump and blender system 50 receives the fracturing fluid and combines it with other components, including proppant from the proppant source 40 and/or additional fluid from the additives 70. The resulting mixture may be pumped down the well 60 under a pressure sufficient to create or enhance one or more fractures in a subterranean zone, for example, to stimulate production of fluids from the zone. Notably, in certain instances, the fracturing fluid producing apparatus 20, fluid source 30, and/or proppant source 40 may be equipped with one or more metering devices (not shown) to control the flow of fluids, proppants, and/or other compositions to the pumping and blender system 50. Such metering devices may permit the pumping and blender system 50 can source from one, some or all of the different sources at a given time, and may facilitate the preparation of fracturing fluids in accordance with the present disclosure using continuous mixing or “on-the-fly” methods. Thus, for example, the pumping and blender system 50 can provide just fracturing fluid into the well at some times, just proppants at other times, and combinations of those components at yet other times.

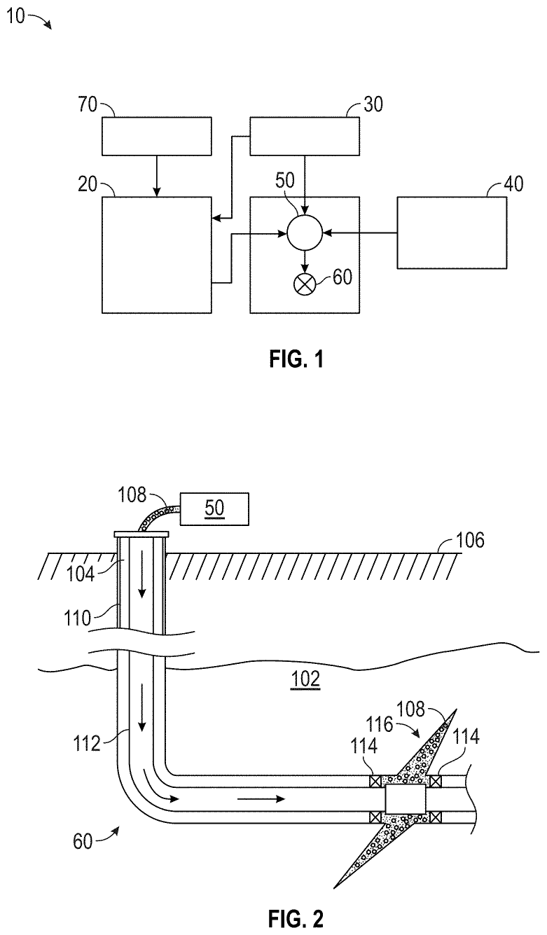

FIG. 2 shows the well 60 during a fracturing operation in a portion of a subterranean formation of interest 102 surrounding a well bore 104. The well bore 104 extends from the surface 106, and the fracturing fluid 108 is applied to a portion of the subterranean formation 102 surrounding the horizontal portion of the well bore. Although shown as vertical deviating to horizontal, the well bore 104 may include horizontal, vertical, slant, curved, and other types of well bore geometries and orientations, and the fracturing treatment may be applied to a subterranean zone surrounding any portion of the well bore. The well bore 104 can include a casing 110 that is cemented or otherwise secured to the well bore wall. The well bore 104 can be uncased or include uncased sections. Perforations can be formed in the casing 110 to allow fracturing fluids and/or other materials to flow into the subterranean formation 102. In cased wells, perforations can be formed using shape charges, a perforating gun, hydro-jetting and/or other tools.

The well is shown with a work string 112 extending from the surface 106 into the well bore 104. The pump and blender system 50 is coupled a work string 112 to pump the fracturing fluid 108 into the well bore 104. The working string 112 may include coiled tubing, jointed pipe, and/or other structures that allow fluid to flow into the well bore 104. The working string 112 can include flow control devices, bypass valves, ports, and or other tools or well devices that control a flow of fluid from the interior of the working string 112 into the subterranean zone 102. For example, the working string 112 may include ports adjacent the well bore wall to communicate the fracturing fluid 108 directly into the subterranean formation 102, and/or the working string 112 may include ports that are spaced apart from the well bore wall to communicate the fracturing fluid 108 into an annulus in the well bore between the working string 112 and the well bore wall.

The working string 112 and/or the well bore 104 may include one or more sets of packers 114 that seal the annulus between the working string 112 and well bore 104 to define an interval of the well bore 104 into which the fracturing fluid 108 will be pumped. FIG. 2 shows two packers 114, one defining an uphole boundary of the interval and one defining the downhole end of the interval. When the fracturing fluid 108 is introduced into well bore 104 (e.g., in FIG. 2, the area of the well bore 104 between packers 114) at a sufficient hydraulic pressure, one or more fractures 116 may be created in the subterranean zone 102. The proppant particulates in the fracturing fluid 108 may enter the fractures 116 where they may remain after the fracturing fluid flows out of the well bore. These proppant particulates may “prop” fractures 116 such that fluids may flow more freely through the fractures 116.

While not specifically illustrated herein, the disclosed methods and compositions may also directly or indirectly affect any transport or delivery equipment used to convey the compositions to the fracturing system 10 such as, for example, any transport vessels, conduits, pipelines, trucks, tubulars, and/or pipes used to fluidically move the compositions from one location to another, any pumps, compressors, or motors used to drive the compositions into motion, any valves or related joints used to regulate the pressure or flow rate of the compositions, and any sensors (i.e., pressure and temperature), gauges, and/or combinations thereof, and the like.

In an illustrative embodiment, a method of treating a subterranean formation is provided. The formation is treated with a gel composition and after the treatment is completed the gel composition is broken through contact of the gel composition with a gel breaking composition. In an embodiment the gel breaking composition is a combination of a conventional gel breaker with an acid. In an embodiment the gel breaking composition is a combination of an oxidizing gel breaker with an acid.

The oxidizing gel breaker and acid can be in any form that is efficacious to breaking the gel. In an embodiment the oxidizing gel breaker and acid can be in an encapsulated form and the encapsulating material breaks down with time or temperature to release the breaker and acid components. In an embodiment the oxidizing gel breaker and acid can be in a form that delays release of the breaker and/or acid components, for a non-limiting example a delayed acid releasing material such as a polylactic acid. The present disclosure is not limited by the type of gel breaking composition and is not limited by the manner of the delivery of the gel breaking composition.

In an illustrative embodiment, the gel composition has an aqueous fluid and a thickening agent that is soluble in the aqueous fluid, such as guar. The present disclosure is not limited by the type of thickening agent used in a gel composition. In illustrative embodiments, the thickening agent can be a polymer based agent or a non-polymer based agent or combinations thereof. Non-polymer based thickening agents can include surfactant fluid systems, viscoelastic surfactant (VES) fluid systems, VES foams, hydrocarbon based systems, systems containing hydrocarbons, liquid CO₂ based systems, CO₂/N₂ based systems, unconventional CO₂ foam based systems, systems containing CO₂ and/or N₂, and others, or combinations thereof.

In illustrative embodiments the gel composition includes nanoparticles. The present disclosure is not limited by the type of nanoparticles used in a gel composition. In illustrative embodiments, the nanoparticles can be natural or synthetic clays. In illustrative embodiments, the nanoparticles can be synthetic clays such as laponite. In certain illustrative embodiments, the nanoparticles can be one or more materials from the group consisting of hectorite, montmorillonite and beidellite.

In an illustrative embodiment, the gel composition has an aqueous fluid, a thickening agent, and nanoparticles. The present disclosure is not limited by the type of thickening agent used in a gel composition. The thickening agent can be a polymer based agent or a non-polymer based agent or combinations thereof. The thickening agent can be a polymer based agent that is linear or non-linear. The thickening agent can be a polymer based agent that is cross-linkable or not cross-linkable. The gel composition is capable of gelling to an increased viscosity and is capable of subsequently breaking back to a reduced viscosity fluid when the gel composition and a breaker package are in physical and chemical contact. In an embodiment the gel breaking composition is a combination of a conventional gel breaker with an acid. In an embodiment the gel breaking composition is a combination of an oxidizing gel breaker with an acid.

In an illustrative embodiment, the gel composition has an aqueous fluid, a cross-linkable polymer that is soluble in the aqueous fluid, and a cross-linking agent. In an embodiment, the cross-linkable polymer can be a hydrophilic polymer that is soluble in the aqueous fluid and is capable of being cross-linked in solution to form a gel. The present disclosure is not limited by the type of cross-linkable polymer used in a gel composition. Examples of these polymers are well known to those skilled in the art. They can include, as non-limiting examples: polyacrylamide and partially hydrolyzed polyacrylamide polymers, polymers and copolymers of acrylic acid and acrylamide, cellulose ethers such as ethyl cellulose, methyl cellulose and cellulose derivatives, diutan, diutan polysaccharide, xanthan and xanthan derivatives, and substituted and unsubstituted galactomannans including guar gum and guar derivatives. Other suitable cross-linkable polymers may also be used and are known to those skilled in the art.

Cross-linking agents are also well known to those experienced in the art. The present disclosure is not limited by the type of cross-linking agent used in a gel composition. Examples of suitable cross-linking agents can include the salts or complexes of the multivalent metals such as chromium, zirconium, titanium and aluminum. These cross-linking agents bond ionically with the polymers to form the cross-linked molecule. Other cross-linking agents may be used and are well known to those in the art. Some of these include formaldehyde releasers such as hexamethylene tetramine or trioxane combined with phenol-based derivatives such as catechol, hydroquinone, or pyrogallol. The amount of cross-linking agent used will vary depending upon the type of polymer and the degree of cross-linking desired. Alternatively, in certain embodiments, the gel composition will not contain any cross-linking agents. Delaying agents and other additives may also be used with the gel composition.

The gel composition further includes nanoparticles. The present disclosure is not limited by the type or size of the nanoparticles used in a gel composition. It is desirable that the nanoparticles be a material that does not adversely affect the formation of the gel composition or its ability of to be injected into the subterranean formation. In an embodiment the nanoparticles can be natural or synthetic clays. In an embodiment the nanoparticles can include one or more materials from the group of hectorite, montmorillonite and beidellite. The nanoparticles can act to increase the viscosity of the gel composition and can reduce the concentration of any cross-linkable polymer in the composition.

In an illustrative embodiment, a gel composition for use in a subterranean formation is provided. The gel composition can include an aqueous fluid, a cross-linkable polymer soluble in the aqueous fluid, a cross-linking agent, nanoparticles and a breaker package. In illustrative embodiments, the nanoparticles can comprise synthetic clays such as laponite. In certain illustrative embodiments, the nanoparticles can be one or more materials from the group consisting of hectorite, montmorillonite and beidellite. The gel composition can be a guar based polymer slurry. The gel composition is capable of gelling to an increased viscosity and is capable of subsequently breaking back to a reduced viscosity fluid when the gel composition and the breaker package are in physical and chemical contact.

In an illustrative embodiment, a method of treating a subterranean formation is provided. A gel composition is provided which includes an aqueous fluid, a cross-linkable polymer soluble in the aqueous fluid, a cross-linking agent, breaker package (containing oxidizer and acid) and nanoparticles. The gel composition can be injected into the subterranean formation and can be used to fracture the subterranean formation. The gel composition can be cross-linked. In certain illustrative embodiments, the nanoparticles can comprise synthetic clays such as laponite. In certain illustrative embodiments, the nanoparticles can be one or more materials from the group consisting of hectorite, montmorillonite and beidellite. The gel composition can be altered, such as with cross-linking, to a gel composition having an increased viscosity. The gel composition can then be altered again to return to a reduced viscosity fluid.

In an embodiment the gel is broken through contact of the gel composition with a gel breaking composition. In an embodiment the gel breaking composition is a combination of a conventional gel breaker with an acid. In an embodiment the gel breaking composition is a combination of an oxidizing gel breaker with an acid.

The addition of nanoparticles to the gel composition used for hydraulic fracturing can effectively reduce the concentration of a thickening agent, such as guar, needed to produce the desired viscosity for hydraulic fracturing because of the nanoparticles' ability to generate viscosity. The addition of nanoparticles and the reduction of the thickening agent can effectively produce a more thermally stable gel system. This is important when completing a well in a high temperature formation or in unconventional reservoirs. A thermally stable gel system is desirable to fracture a high temperature formation so that the gel does not break down prior to the completion of the fracture treatment.

A problem that can be encountered when using a thermally stable nanoparticle gel system is an inability to break the gel after the completion of the fracture treatment. The gel in a high viscosity state within the formation can act as an impediment to fluid flow through the formation and the induced fractures created.

To facilitate a better understanding of the presently disclosed subject matter, the following examples are given. In no way should the following examples be read to limit, or define, the scope of the presently disclosed subject matter.

### Examples

A base fluid of water, carboxymethyl cellulose (CMC) in a ratio of 401b/1000 gal, along with 2% THERMA-VIS™ viscosifier were mixed to form a thermally stable nanoparticle gel composition. THERMA-VIS™ viscosifer is a synthetic clay nanoparticle based viscosifier used in high temperature water based drilling fluids and is commercially available from Halliburton of Houston, Tex. CMC is commonly known in the art as a gelling agent. A conventional gel of the same composition but without the nanoparticle based viscosifier was used as a comparative gel.

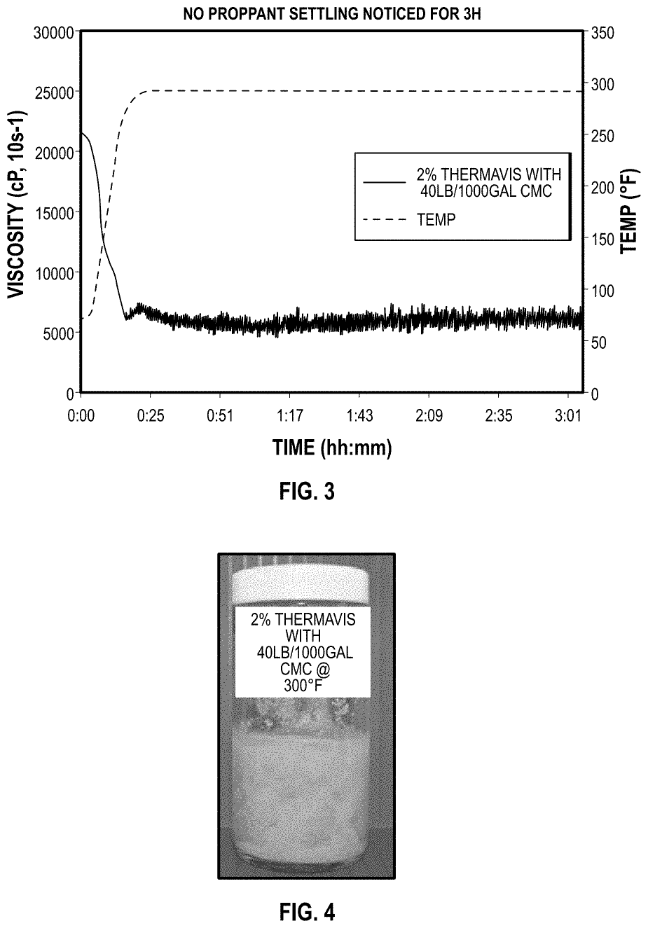

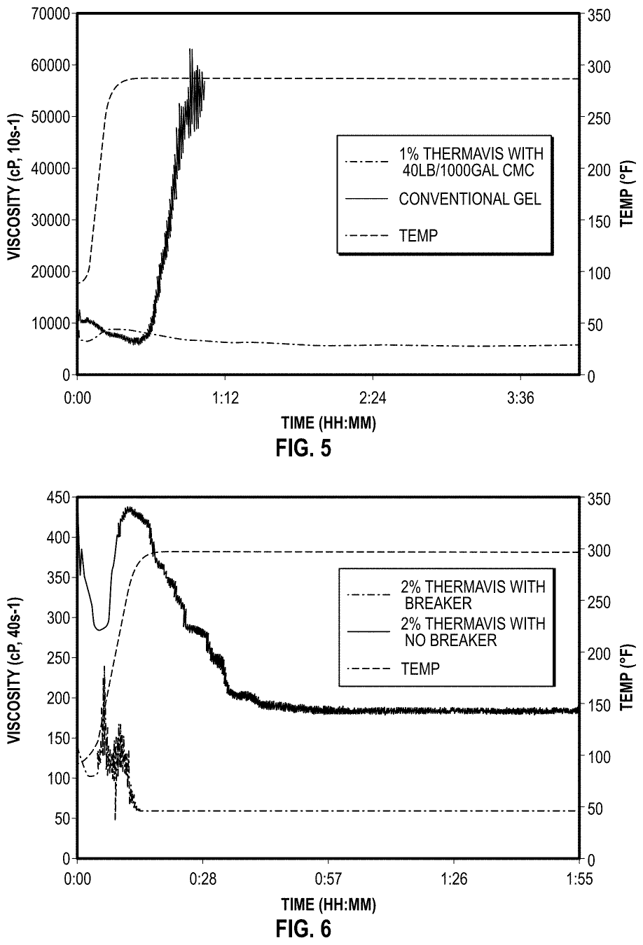

The thermal stability of the nanoparticle gel composition was tested at 250° F. and 300° F. FIG. 3, FIG. 4 and FIG. 5 summarize the performance of the gel at the tested temperature. A Halliburton testing device as described in U.S. Pat. No. 6,782,735, was used to record the measurements. As shown in FIGS. 3 and 5, no change in viscosity of the nanoparticle gel composition was noticed at test temperatures whereas a sudden increase in viscosity in the convention gel system was noticed at 250° F. suggesting proppant settling as seen in FIG. 5.

To test the breaking of the nanoparticle gel composition, a breaker package (containing a buffer to lower the pH and an oxidizer) was added to the gel composition and the viscosity was tested using a Chandler 5550 viscometer. The breaker package consisted of BA-20™ buffering agent (1 gal/1000 gal) and Optiflo-III breaker (0.5 lb/1000 gal). BA-20™ buffering agent is commercially available from Halliburton. Optiflo-III oxidizing breaker is commercially available from Halliburton. When the gel composition without breaker was tested the gel maintained a viscosity of greater than 150 cP which indicated the gel composition remained stable at the testing temperature of 300° F. as shown in FIG. 6. Whereas when the breaker package was added to the gel composition, viscosity dropped below 50 cp as indicated in FIG. 6.

In a separate test, filter cake was made by mixing 150 liters of Houston tap water with 720 grams of WG39™ a gelling agent commercially available from Halliburton. 1125 grams of THERMA-VIS™ viscosifer was then added to the mixture and the pH was adjusted using BA20™ buffering agent commercially available from Halliburton. CL-23™ crosslinking agent is commercially available from Halliburton was then added at a concentration of 0.5 gpt and a rate of 0.65 ml/min. Fluid loss was tested at 120° F. with a flow rate maintained at 1.3 liters/min for 1 hour. After the test the cells were disassembled and the filter cake was collected from each of the cores. 2 g of filter cake was immersed in 10% HCL and 1 lb/1000 gal Optiflo-III breaker, after 24 hours at 200° F. complete filter cake dissolution was noticed. In another experiment BA20™ buffering agent and Optiflo-III breaker (1 lb/1000 gal) was used to break the gel and a slower break was noticed. Approximately 50% drop in weight was observed after 24 hours and complete dissolution occurred after 48 hours.

In an embodiment the gel is broken through contact of the gel composition with a gel breaking composition. In an embodiment the gel breaking composition is a combination of a conventional gel breaker with an acid.

Conventional breakers that can be utilized with the present disclosure can include oxidizing agents. Non-limiting examples can include oxidative breakers such as a bromate, a chlorite, a peroxide, a perborate, a percarbonate, a perphosphate, a persulfate, an oxyacid, an oxyanion of a halogen or a combination thereof. Peroxide breakers can include organic or inorganic peroxides. Peroxides can include hydrogen peroxide, calcium peroxide, magnesium peroxide. The oxidizer breaker can also be present in a time release form such as a coated form. Non-limiting examples of a coated breaker include Optiflo-II and Optiflo-III breakers both commercially available from Halliburton.

Acids that can be utilized with the present disclosure can include any pH reducing agents. Non-limiting examples can include: hydrochloric acid, acetic acid, formic acid, hydroxycarboxylic (mono, di and tri-carboxylic) acids such as glycolic, lactic, malonic, succinic, gluconic, or citric. Other acidic fluids include salts of hydrochloride acid (HCl) such as urea*HCl, glycine*HCl, and amino-hydrochloride salts. Other non-limiting examples are N,N,-diacetic acid or a salt thereof (GLDA), methylglycine N,N-diacetic acid or a salt thereof (MGDA), and/or N-hydroxyethyl ethylenediamine N,N′,′-triacetic acid or a salt thereof (HEDTA). N-Phosphonomethyl Iminodiacetic Acid (PMIDA) can also be used. Other non-limiting examples are organic and inorganic acids, such as sulfonated ester, phosphate ester, organo orthoformate, organo orthoacetate, or triethyl citrate. Polymeric acid generating materials such as polylactic acid (PLA) and polyglutamic acid (PGA) can also be used. Coated acids or other time release modifications can be used to provide a delayed release of the acid.

The gel breaking composition of conventional breaker with an acid can be of any effective mixture of the two. Non-limiting examples can include: 99% oxidizer/1% acid, 95% oxidizer/5% acid, 90% oxidizer/10% acid, 85% oxidizer/15% acid, 80% oxidizer/20% acid, 75% oxidizer/25% acid, 70% oxidizer/30% acid, 65% oxidizer/35% acid, 60% oxidizer/40% acid, 55% oxidizer/45% acid, 50% oxidizer/50% acid, 45% oxidizer/55% acid, 40% oxidizer/60% acid, 35% oxidizer/65% acid, 30% oxidizer/70% acid, 25% oxidizer/75% acid, 20% oxidizer/80% acid, 15% oxidizer/85% acid, 10% oxidizer/90% acid, 5% oxidizer/95% acid, and 1% oxidizer/99% acid.

An embodiment of the present disclosure is a treatment fluid composition for use in a subterranean formation. The composition includes an aqueous fluid, a thickening agent, nanoparticles, and a gel breaker. The aqueous fluid, thickening agent and nanoparticles form a thermally resistant treatment gel that is stable until the addition of the gel breaker. The gel breaker can include a conventional breaker and an acid. The conventional breaker can be an oxidizing agent. The nanoparticles can be natural or synthetic clays and can optionally be one or more materials from the group consisting of hectorite, montmorillonite and beidellite. In an embodiment the gel breaker is in a time released form wherein the contact between the gel breaker and the thermally resistant treatment gel is delayed by a predetermined time, for example the gel breaker components can be coated or encapsulated in a manner that enables their release to happen at a delayed time, such as for example after 1 hour of pumping the treatment fluid into the formation.

In certain illustrative embodiments, the gel composition can be used as a loss circulation material or combined with drilling fluids. In certain aspects, the nanoparticles may require sufficient hydration time in the form of two or more separate slurries. When the technology is ready to be deployed, the various slurries and mobile phase can be homogenized and injected down hole as a fracturing fluid.

Other additives suitable for use in operations in subterranean formations also may be optionally added to the gel composition. These other additives can include, but are not limited to, biocide, scale inhibitor, corrosion inhibitor, paraffin inhibitor, asphaletene inhibitor, iron control and other commonly used oilfield chemicals and combinations thereof. A person having ordinary skill in the art, with the benefit of this disclosure, can determine the type and amount of additive useful for a particular application and desired result.

In some embodiments, the methods can further comprise performing a treatment operation in the portion of the subterranean formation such as, for example, a fracturing operation, an acidizing operation, a gravel packing operation, or a combination thereof. In some embodiments, the methods can further comprise forming a proppant pack or a gravel pack in the portion of the subterranean formation being treated.

The aqueous solutions of the present disclosure may also contain other well treatment compounds such as but not necessarily limited to clay stabilizers, scale inhibitors, and corrosion inhibitors. For example, the aqueous solution may also contain salts suitable for inhibiting the swelling of clays.

Further, the present treatment fluids can optionally comprise any number of additional additives commonly used in treatment fluids including, for example, foaming agents, defoaming agents, antifoam agents, emulsifying agents, de-emulsifying agents, iron control agents, salts, acids, fluid loss control additives, gas, catalysts, dispersants, flocculants, scavengers (e.g., H₂S scavengers, CO₂ scavengers or O₂ scavengers), lubricants, breakers, friction reducers, bridging agents, weighting agents, solubilizers, pH control agents (e.g., buffers), hydrate inhibitors, consolidating agents, bactericides, biocides and the like. Combinations of these additives can be used as well.

As defined herein, a “treatment fluid” is a fluid that is placed in a subterranean formation in order to achieve a desired purpose. Treatment fluids can be used in a variety of subterranean operations, including, but not limited to, stimulation operations, remedial operations, fracturing operations, and gravel packing operations. As used herein, the terms “treatment” and “treating” refer to any subterranean operation that uses a fluid in conjunction with performing a desired function and/or achieving a desired purpose. The terms “treatment” and “treating,” as used herein, do not imply any particular action by the fluid or any particular component thereof unless otherwise specified. Treatment fluids can include, without limitation, fracturing fluids, acidizing fluids, conformance treatments, damage control fluids, remediation fluids, scale removal and inhibition fluids, and the like.

Treatment fluids of the present disclosure generally comprise an aqueous phase base fluid. Aqueous phase base fluids can include, for example, fresh water, acidified water, salt water, seawater, brine, or an aqueous salt solution. In some embodiments, the treatment fluids can also contain small amounts of hydrocarbons such that the aqueous base fluid remains as the continuous phase.

In some embodiments, the base fluid comprises an aqueous salt solution. Such aqueous salt solutions can have a salt concentration ranging between about 0.1% and about 10% by weight. The salt concentration can range between about 1% and about 10% by weight in some embodiments or between about 2% and about 5% by weight in other embodiments. In some embodiments the aqueous salt solution can be 2% KCl.

In other embodiments, the base fluid can comprise fresh water. One of ordinary skill in the art will recognize that fresh water can be obtained from any available source including treated water sources (e.g., drinking water, reclaimed wastewater or desalinated water) or untreated water sources (e.g., streams, lakes or rivers). One of ordinary skill in the art will further recognize that fresh water sources can contain minor amounts of salts, biological materials and other substances that do not substantially affect its use as a base fluid in the present embodiments.

The treatment solutions and methods of the present disclosure are applicable in both newly-drilled formations and in formations requiring re-stimulation. The solutions and methods of the present disclosure are particularly useful for formation re-stimulations where hydrocarbons will be present in the formation zones.

The various embodiments of the present disclosure can be joined in combination with other embodiments of the disclosure and the listed embodiments herein are not meant to limit the disclosure. All combinations of various embodiments of the disclosure are enabled, even if not given in a particular example herein.

While illustrative embodiments have been depicted and described, modifications thereof can be made by one skilled in the art without departing from the scope of the disclosure. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Moreover, the indefinite articles “a” or “an”, as used in the claims, are defined herein to mean one or more than one of the element that it introduces. If there is any conflict in the usages of a word or term in this specification and one or more patent or other documents, the definitions that are consistent with this specification should be adopted. While compositions and methods are described in terms of “comprising,” “containing,” or “including” various components or steps, the compositions and methods can also “consist essentially of” or “consist of” the various components and steps. Also, the terms in the claims have their plain, ordinary meaning unless otherwise explicitly and clearly defined by the patentee.

Depending on the context, all references herein to the “disclosure” may in some cases refer to certain specific embodiments only. In other cases it may refer to subject matter recited in one or more, but not necessarily all, of the claims. While the foregoing is directed to embodiments, versions and examples of the present disclosure, which are included to enable a person of ordinary skill in the art to make and use the disclosures when the information in this patent is combined with available information and technology, the disclosures are not limited to only these particular embodiments, versions and examples.

Numerous other modifications, equivalents, and alternatives, will become apparent to those skilled in the art once the above disclosure is fully appreciated. While embodiments of the disclosure have been shown and described, modifications thereof can be made by one skilled in the art without departing from the teachings of this disclosure. The embodiments described herein are exemplary only, and are not intended to be limiting. Many variations and modifications of the disclosure disclosed herein are possible and are within the scope of the disclosure.

Use of the term “optionally” with respect to any element of a claim is intended to mean that the subject element is required, or alternatively, is not required. Both alternatives are intended to be within the scope of the claim. It is intended that the following claims be interpreted to embrace all such modifications, equivalents, and alternatives where applicable. Other and further embodiments, versions and examples of the disclosure may be devised without departing from the basic scope thereof and the scope thereof is determined by the claims that follow.

1. A method of treating a subterranean formation, the method comprising:
providing a treatment gel comprising an aqueous fluid, a thickening agent, and nanoparticles;
placing the treatment gel in at least a portion of a subterranean formation; and
placing a gel breaker in at least a portion of the subterranean formation to break the treatment gel to a residual treatment fluid.

2. The method of claim 1, wherein the residual treatment fluid has a viscosity less than the treatment gel.

3. The method of claim 1, wherein the gel breaker is injected with the treatment gel into the subterranean formation.

4. The method of claim 3, wherein the gel breaker is time delayed before coming into contact with the treatment gel.

5. The method of claim 1, wherein the gel breaker comprises a conventional breaker and an acid.

6. The method of claim 5, wherein the conventional breaker is an oxidizing agent.

7. The method of claim 1, wherein the thickening agent is a cross-linkable polymer.

8. The method of claim 7, wherein the treatment fluid comprises a cross-linkable polymer soluble in the aqueous fluid and a cross-linking agent.

9. The method of claim 8, further comprising cross-linking the cross-linkable polymer within the treatment fluid to form a cross-linked polymer.

10. The method of claim 9, further comprising breaking the cross-linked polymer.

11. The method of claim 1, wherein the treatment gel is introduced into a subterranean formation using one or more pumps.

12. A method of treating a subterranean formation, the method comprising:
providing a treatment fluid comprising an aqueous fluid, a cross-linkable polymer soluble in the aqueous fluid, a cross-linking agent and nanoparticles;
cross-linking the cross-linkable polymer within the treatment fluid to form a thermally resistant gel comprising a cross-linked polymer;
placing the thermally resistant gel in at least a portion of a subterranean formation using one or more pumps;
placing a gel breaker in at least a portion of the subterranean formation; and
breaking the cross-linked polymer.

13. The method of claim 12, wherein the gel breaker comprises an oxidizer and an acid.

14. A treatment fluid composition for use in a subterranean formation comprising:
an aqueous fluid;
a thickening agent;
nanoparticles; and
a gel breaker.

15. The composition of claim 14 wherein the aqueous fluid, thickening agent and nanoparticles form a thermally resistant treatment gel that is stable until the thermally resistant treatment gel comes in contact with the gel breaker.

16. The composition of claim 14 wherein the gel breaker comprises a conventional breaker and an acid.

17. The composition of claim 16, wherein the conventional breaker is an oxidizing agent.

18. The composition of claim 14, wherein the nanoparticles comprise natural or synthetic clays.

19. The composition of claim 14, wherein the nanoparticles comprise one or more materials from the group consisting of hectorite, montmorillonite and beidellite.

20. The composition of claim 15, wherein the gel breaker is time delayed before coming into contact with the thermally resistant treatment gel.
